(19) United States
(12) Patent Application Publication
(10) Pub. No.: US 2012/0073151 A1
(43) Pub. Date: Mar. 29, 2012

(54) MOVABLE MEASURING RULER DEVICE FOR MEASURING EXTERNAL CONTOUR PRECISION OF VEHICLE BODY

(75) Inventor: XIAOYANG XU, Jilin (CN)

(73) Assignee: CHANGCHUN RAILWAY VEHICLES CO., LTD., Jilin (CN)

(21) Appl. No.: 13/310,393

(22) Filed: Dec. 2, 2011

Related U.S. Application Data
(63) Continuation of application No. PCT/CN2010/074801, filed on Jun. 30, 2010.

(30) Foreign Application Priority Data
Sep. 11, 2009 (CN) 200920094343.3

(51) Int. Cl. B43L 13/00

(52) U.S. Cl. 33/18.1

(57) ABSTRACT

A movable measuring ruler device for measuring an external contour precision of a vehicle body comprising a movable trolley with a rail and an upright detecting ruler, wherein the upright detecting ruler is fixed on a frame of the movable trolley. The advantageous effect of the present invention lies in that measurement of external contour or intended parts of the vehicle body can be accomplished during rail traveling of the movable trolley, which is installed in parallel with the longitudinal center axis of a vehicle body and includes an upright detecting ruler, thereby a quick and accurate measurement is achieved.

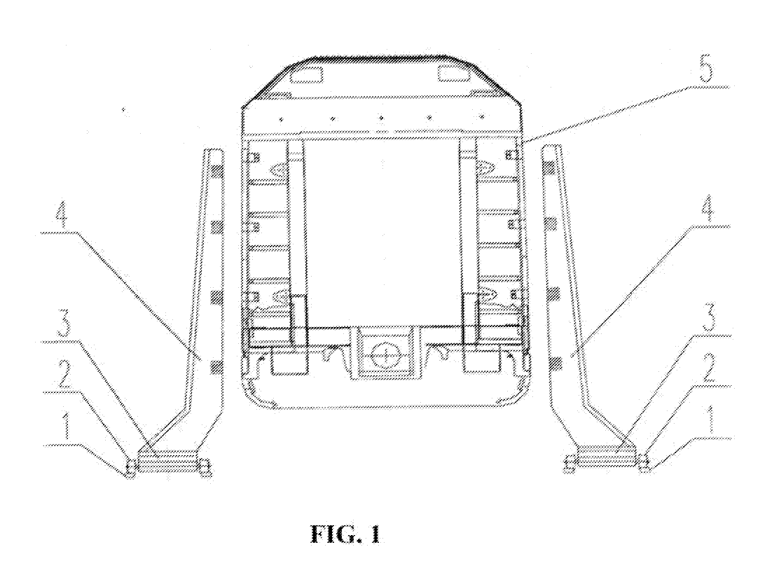

### CROSS-REFERENCE TO RELATED APPLICATIONS

This application is a continuation of International Application No. PCT/CN2010/074801, filed on Jun. 30, 2010, which claims the priority benefit of China Patent Application No. 200920094343.3, filed on Sep. 11, 2009. The contents of the above identified applications are incorporated herein by reference in their entirety.

### FIELD OF THE TECHNOLOGY

The present invention belongs to the technical field of railway vehicle manufacture, and more specifically relates to a device for measuring an external contour precision during assembling a railway vehicle body with a steel structure.

### BACKGROUND

At present, there is no measuring device specialized in measuring external contour precision during assembling a railway vehicle body. The conventional measurement method of using a tie line or a tape measure is undesirable and inaccurate, it can not guarantee the accuracy of the external contour precision during assembling the railway vehicle body with a steel structure.

### SUMMARY

It is an object of the present invention to provide a movable measuring ruler device for measuring external contour precision of a vehicle body for solving the inaccurate problem of the external contour precision during assembling a railway vehicle body with a steel structure and improving the quality and the efficiency for assembling the vehicle body.

In order to realize the above object, the present invention provides a movable measuring ruler device for measuring an external contour precision of a vehicle body, which comprises a movable trolley with a rail and an upright detecting ruler, wherein the upright detecting ruler is fixed on a frame of the movable trolley.

The advantageous effect of the present invention lies in that measurement of external contour or intended parts of the vehicle body can be accomplished during rail traveling of the movable trolley, which is installed in parallel with the longitudinal center axis of a vehicle body and includes an upright detecting ruler, thereby a quick and accurate measurement is achieved.

### BRIEF DESCRIPTION OF THE DRAWINGS

The drawing is a structural schematic diagram of a movable measuring ruler device according to an embodiment of the present invention.

### DETAILED DESCRIPTION

Referring to the drawing, movable trolley rails 1 are paved at the two sides of a railway vehicle 5, which are in parallel with the longitudinal center axis of a vehicle body of the railway vehicle 5, and movable trolley wheels 2 can stably travel on the movable trolley rails 1 by engaging with the movable trolley rails 1. In the embodiment shown in the FIGURE, rail 1 in each side of the railway vehicle 5 has two lines, and accordingly movable trolley wheel 2 has two rows of wheels engaging the two lines of rail 1. In another embodiment, rail 1 in each side of the railway vehicle 5 may have a single line, and accordingly movable trolley wheel 2 has one row of wheel engaging the single line of rail 1. A movable trolley frame 3 is fixed on the movable trolley wheels 2, and an upright detecting ruler 4 with scale marks is arranged on the movable trolley frame 3. When the movable trolley frame 3 is pushed manually or driven by a motor (not shown), the upright detecting ruler 4 with the scale marks always moves in parallel with the longitudinal center axis of the vehicle body of the railway vehicle 5 and keeps equal distance with the width direction of the railway vehicle 5. The upright detecting ruler 4 comprises an elongated upright body with scale marks thereon. In one embodiment, the edge and/or surface of the elongated upright body facing the railway vehicle 5 is a straight line or a flat surface extending vertically. The height of the upright detecting ruler 4 corresponds to that of the railway vehicle 5 or lower than the later. The change in width of the railway vehicle 5 is detected through the change in the gap between the upright detecting ruler 4 with the scale marks and the railway vehicle 5. The change in height of the railway vehicle 5 is detected through the change between some position of the railway vehicle 5 and the numerical value of the scale marks on the upright detecting ruler 4 with the scale marks. Therefore, the width change and the height change of the surface position of the external contour of the railway vehicle 5 can be measured. To provide more room for railway vehicle 5 during assembling, the elongated upright body of the upright detecting ruler 4 can be shaped so that the upper portion with scale marks extends towards the railway vehicle 5 and away from rail 1 as shown in the FIGURE.

What is claimed is:

1. A movable measuring ruler device for measuring external contour precision of a vehicle body, comprising a movable trolley with a rail and an upright detecting ruler, wherein the upright detecting ruler is fixed on a frame of the movable trolley.
